(19) United States
(12) Patent Application Publication
(10) Pub. No.: US 2020/0204234 A1
(43) Pub. Date: Jun. 25, 2020

(54) MILLIMETER WAVE ANTENNA MODULE CONTROL

(71) Applicant: QUALCOMM Incorporated, San Diego, CA (US)

(72) Inventors: Jun Zhu, San Diego, CA (US); Ruhua He, San Diego, CA (US); Mihir Vijay Laghate, San Diego, CA (US); Jafar Mohseni, San Diego, CA (US); Raghu Narayan Challa, San Diego, CA (US); Alexei Yurievitch Gorokhov, San Diego, CA (US)

(21) Appl. No.: 16/721,779

(22) Filed: Dec. 19, 2019

Related U.S. Application Data
(60) Provisional application No. 62/783,989, filed on Dec. 21, 2018.

(51) Int. Cl. H04B 7/06; H04B 7/08; H04L 5/00; H04B 17/318; H04B 17/336

(52) U.S. Cl. CPC H04B 7/0608; H04B 7/088; H04B 17/336; H04B 17/318; H04L 5/0051

(57) ABSTRACT

Methods, systems, and devices for wireless communication are described. Generally, the described techniques provide for managing antenna modules, (such as radio frequency integrated circuits (RFICs)) to maximize power savings and minimize latency at a user equipment (UE). As described herein, a UE may identify an RFIC to use as an active RFIC for receiving a scheduled transmission based on an active transmission configuration indication (TCI) state or serving beam of a base station to be used for the scheduled transmission. The UE may then identify one or more remaining RFICs at the UE as either candidate RFICs for potentially replacing the active RFIC or as unused RFICs, and the UE may receive the scheduled transmission via the active RFIC or via a replacement active RFIC selected from the candidate RFICs.

### CROSS REFERENCE

The present application for patent claims the benefit of U.S. Provisional Patent Application No. 62/783,989 by ZHU et al., entitled “MILLIMETER WAVE RADIO FREQUENCY INTEGRATED CIRCUIT CONTROL,” filed Dec. 21, 2018, assigned to the assignee hereof, and expressly incorporated herein.

### BACKGROUND

The following relates generally to wireless communications and more specifically to millimeter wave (mmW) antenna module control, also referenced herein as radio frequency integrated circuit (RFIC) control.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

A wireless multiple-access communications system may include a number of base stations or network access nodes, each simultaneously supporting communication for multiple communication devices, which may be otherwise known as user equipment (UE). In some wireless communications systems, a UE may support communications with a base station using one or more beams. In such systems, the UE may include multiple antenna modules or RFICs used to generate the beams for communicating with the base station. In some cases, the UE may support techniques for transitioning at least some of the antenna modules or RFICs into a sleep mode to save power. Techniques for managing the transitioning of antenna modules into a sleep mode may be deficient.

### SUMMARY

The described techniques relate to improved methods, systems, devices, and apparatuses that support millimeter wave (mmW) antenna module control, also referred to herein as radio frequency integrated circuit (RFIC) control. Generally, the described techniques provide for managing antenna modules to maximize power savings and minimize latency at a user equipment (UE). As described herein, a UE may identify an antenna module or RFIC to use as an active antenna module for receiving a scheduled transmission based on an active transmission configuration indication (TCI) state or serving beam of a base station to be used for the scheduled transmission. The UE may then identify (or categorize) one or more remaining antenna modules at the UE as either candidate antenna modules or RFICs for potentially replacing the active antenna modules or as unused antenna modules, and the UE may receive the scheduled transmission via the active antenna module or via a replacement active antenna module selected from the candidate antenna modules.

A method for wireless communication at a UE is described. The method may include identifying an active TCI state or serving beam of a base station to be used for one or more scheduled transmissions, identifying an antenna module at the UE to be used as an active antenna module for receipt of the one or more scheduled transmissions via the active TCI state or serving beam, identifying one or more remaining antenna modules at the UE as either candidate antenna modules for potentially replacing the active antenna module within a leading time or as unused antenna modules, and receiving the one or more scheduled transmissions via the active antenna module or via a replacement active antenna module selected from the candidate antenna modules.

An apparatus for wireless communication at a UE is described. The apparatus may include a processor, memory in electronic communication with the processor, and instructions stored in the memory. The instructions may be executable by the processor to cause the apparatus to identify an active TCI state or serving beam of a base station to be used for one or more scheduled transmissions, identify an antenna module at the UE to be used as an active antenna module for receipt of the one or more scheduled transmissions via the active TCI state or serving beam, identify one or more remaining antenna modules at the UE as either candidate antenna modules for potentially replacing the active antenna module within a leading time or as unused antenna modules, and receive the one or more scheduled transmissions via the active antenna module or via a replacement active antenna module selected from the candidate antenna modules.

Another apparatus for wireless communication at a UE is described. The apparatus may include means for identifying an active TCI state or serving beam of a base station to be used for one or more scheduled transmissions, identifying an antenna module at the UE to be used as an active antenna module for receipt of the one or more scheduled transmissions via the active TCI state or serving beam, identifying one or more remaining antenna modules at the UE as either candidate antenna modules for potentially replacing the active antenna module within a leading time or as unused antenna modules, and receiving the one or more scheduled transmissions via the active antenna module or via a replacement active antenna module selected from the candidate antenna modules.

A non-transitory computer-readable medium storing code for wireless communication at a UE is described. The code may include instructions executable by a processor to identify an active TCI state or serving beam of a base station to be used for one or more scheduled transmissions, identify an antenna module at the UE to be used as an active antenna module for receipt of the one or more scheduled transmissions via the active TCI state or serving beam, identify one or more remaining antenna modules at the UE as either candidate antenna modules for potentially replacing the active antenna module within a leading time or as unused antenna modules, and receive the one or more scheduled transmissions via the active antenna module or via a replacement active antenna module selected from the candidate antenna modules.

### BRIEF DESCRIPTION OF THE DRAWINGS

FIG. 1 illustrates an example of a wireless communications system that supports millimeter wave (mmW) antenna module control or radio frequency integrated circuit (RFIC) control in accordance with aspects of the present disclosure.

FIG. 2 illustrates an example of a user equipment (UE) with multiple RFICs in accordance with aspects of the present disclosure.

FIG. 3 illustrates an example of a wireless communications system that supports mmW antenna module control in accordance with aspects of the present disclosure.

FIG. 4 illustrates an example of a state diagram in accordance with aspects of the present disclosure.

FIG. 5 illustrates a table that provides further details for active RFICs, candidate RFICs, and unused RFICs in accordance with aspects of the present disclosure.

FIGS. 6 and 7 show block diagrams of devices that support mmW antenna module control in accordance with aspects of the present disclosure.

FIG. 8 shows a block diagram of a communications manager that supports mmW antenna module control in accordance with aspects of the present disclosure.

FIG. 9 shows a diagram of a system including a device that supports mmW antenna module control in accordance with aspects of the present disclosure.

FIG. 10 shows a flowchart illustrating methods that support mmW antenna module control in accordance with aspects of the present disclosure.

### DETAILED DESCRIPTION

In some wireless communications systems (e.g., millimeter wave (mmW) systems), a user equipment (UE) may communicate with a base station using one or more beams. In such systems, a UE may include multiple antenna modules used to generate the beams for communicating with a base station. In some aspects, antenna modules may be referred to as radio frequency integrated circuits (RFICs). In some cases, a UE may use a set of antenna modules (or RFICs) to communicate with a base station, and a remaining set of antenna modules (or RFICs) at the UE may be unused. In such cases, the UE may transition unused antenna modules (such as, RFICs) to a power saving mode to limit power consumption at the UE. Some wireless communications systems may support multiple power saving modes, each mode associated with a certain amount of power savings and a latency for transitioning an RFIC from an active mode to the power saving mode or from the power saving mode to an active mode. However, conventional techniques for managing the power modes of antenna modules (such as, RFICs) may be deficient (e.g., may not consider the inputs from components which may use the antenna modules for communications).

As described herein, a wireless communications system may support efficient techniques for managing antenna modules (such as, RFICs) to maximize power savings and minimize latency. A UE may identify an RFIC to use as an active RFIC for receiving a scheduled transmission based on a serving beam of a base station to be used for the scheduled transmission. The UE may then categorize or identify the remaining RFICs at the UE as either candidate RFICs for potentially replacing the active RFIC or as unused RFICs, and the UE may receive the scheduled transmission via the active RFIC or via a replacement active RFIC selected from the candidate RFICs. The RFICs categorized as candidate RFICs may correspond to RFICs which may potentially be needed for subsequent communications and may be maintained in a power saving mode associated with low power savings and low latency for transitioning the RFICs back to an active mode. Alternatively, unused RFICs may be maintained in a power saving mode associated with high power savings and high latency for transitioning the RFICs back to an active mode (i.e., since the unused RFICs may not be needed for subsequent communications).

Aspects of the disclosure introduced above are described herein in the context of a wireless communications system. Examples of processes and signaling exchanges that support mmW antenna module control are then described. Aspects of the disclosure are further illustrated by and described with reference to apparatus diagrams, system diagrams, and flowcharts that relate to mmW antenna module control.

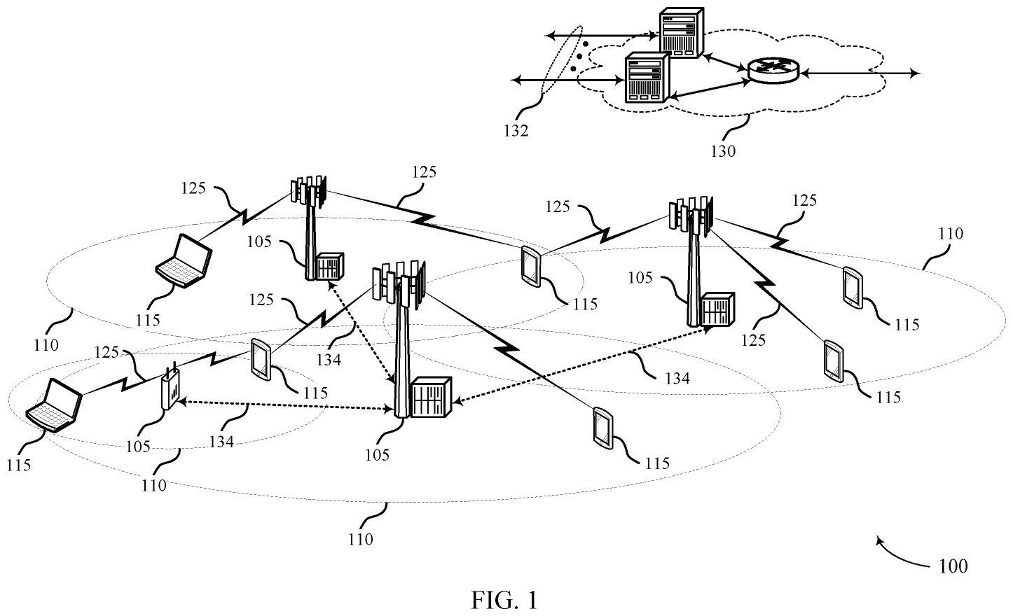

FIG. 1 illustrates an example of a wireless communications system 100 that supports mmW antenna module control in accordance with aspects of the present disclosure. The wireless communications system 100 includes base stations 105, UEs 115, and a core network 130. In some examples, the wireless communications system 100 may be a Long-Term Evolution (LTE) network, an LTE-Advanced (LTE-A) network, an LTE-A Pro network, or a New Radio (NR) network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation NodeB or giga-NodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. The uplink transmissions may include uplink data transmissions in a physical uplink shared channel (PUSCH) or uplink control information transmissions in a physical uplink control channel (PUCCH), and the downlink transmissions may include downlink data transmissions in a physical downlink shared channel (PDSCH) or downlink control information (DCI) transmissions in a physical downlink control channel (PDCCH). In some cases, a base station 105 may also transmit control information in a Medium Access Control (MAC) control element (MAC-CE). Downlink transmissions may also be called forward link transmissions while uplink transmissions may also be called reverse link transmissions.

The geographic coverage area 110 for a base station 105 may be divided into sectors making up a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

The term “cell” may refer to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

The term “carrier” may refer to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an evolved universal mobile telecommunication system terrestrial radio access (E-UTRA) absolute radio frequency channel number (EARFCN)) and may be positioned according to a channel raster for discovery by UEs 115. Carriers may be downlink or uplink (e.g., in a frequency division duplexing (FDD) mode) or may be configured to carry downlink and uplink communications (e.g., in a time division duplexing (TDD) mode). In some examples, signal waveforms transmitted over a carrier may be made up of multiple sub-carriers (e.g., using multi-carrier modulation (MCM) techniques such as orthogonal frequency division multiplexing (OFDM) or discrete Fourier transform spread OFDM (DFT-S-OFDM)).

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Base stations 105 may communicate with the core network 130 and with one another. For example, base stations 105 may interface with the core network 130 through backhaul links 132 (e.g., via an S1, N2, N3, or another interface). Base stations 105 may communicate with one another over backhaul links 134 (e.g., via an X2, Xn, or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz. Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that may be capable of tolerating interference from other users.

Wireless communications system 100 may also operate in an extremely high frequency (EHF) region of the spectrum (e.g., from 30 GHz to 300 GHz), also known as the millimeter band. In some examples, wireless communications system 100 may support mmW communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some examples, base station 105 or UE 115 may be equipped with multiple antennas, which may be used to employ techniques such as transmit diversity, receive diversity, multiple-input multiple-output (MIMO) communications, or beamforming. For example, wireless communications system 100 may use a transmission scheme between a transmitting device (e.g., a base station 105) and a receiving device (e.g., a UE 115), where the transmitting device is equipped with multiple antennas and the receiving device is equipped with one or more antennas. MIMO communications may employ multipath signal propagation to increase the spectral efficiency by transmitting or receiving multiple signals via different spatial layers, which may be referred to as spatial multiplexing.

The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 105 may use multiple antennas or antenna arrays to conduct beamforming operations for directional communications with a UE 115. For instance, some signals (e.g., synchronization signals, reference signals, beam selection signals, or other control signals) may be transmitted by a base station 105 multiple times in different directions, which may include a signal being transmitted according to different beamforming weight sets associated with different directions of transmission. Transmissions in different beam directions may be used to identify (e.g., by the base station 105 or a receiving device, such as a UE 115) a beam direction for subsequent transmission and/or reception by the base station 105. Transmissions in different beam directions may be referred to as a beam sweep and may be used in a beam management procedure (e.g., P1, P2, or P3 beam management procedure) to allow a base station 105 and UE 115 to identify appropriate beams (e.g., transmit and receive beams) for communicating (e.g., based on reference signal received power (RSRP) beam measurements and other beam measurements).

In a P1 beam management procedure (e.g., a beam selection procedure), a base station 105 may sweep multiple transmit beams (e.g., synchronization signal blocks (SSBs) or channel state information reference signals (CSI-RSs) transmitted on the beams) and a UE 115 may test multiple receive beams against each of the transmit beams to identify a suitable transmit beam and receive beam pair (e.g., where the UE 115 may report the best transmit beam to the base station 105 in a beam report). In a P2 beam management procedure (e.g., a beam reselection procedure), a base station 105 may sweep multiple transmit beams and a UE 115 may identify and report a best transmit beam to base station 105. In a P3 beam management procedure (e.g., a beam reselection procedure), a base station 105 may transmit on a single transmit beam (e.g., a current serving beam), and a UE 115 may test multiple receive beams against the transmit beam to identify a best receive beam for communicating with the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based at least in in part on a signal that was transmitted in different beam directions. For example, a UE 115 may receive one or more of the signals transmitted by the base station 105 in different directions, and the UE 115 may report to the base station 105 an indication of the signal it received with a highest signal quality, or an otherwise acceptable signal quality. Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or transmitting a signal in a single direction (e.g., for transmitting data to a receiving device).

A receiving device (e.g., a UE 115, which may be an example of a mmW receiving device) may try multiple receive beams when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions. In some examples, a receiving device may use a single receive beam to receive along a single beam direction (e.g., when receiving a data signal). The single receive beam may be aligned in a beam direction determined based on listening according to different receive beam directions (e.g., a beam direction determined to have a highest signal strength, highest signal-to-noise ratio, or otherwise acceptable signal quality based on listening according to multiple beam directions).

In some cases, the antennas of a base station 105 or UE 115 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

Wireless communications system 100 may be a packet-based network that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A MAC layer may perform priority handling and multiplexing of logical channels into transport channels. The MAC layer may also use hybrid automatic repeat request (HARQ) to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical layer, transport channels may be mapped to physical channels.

In some cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Tₛ=1/30,720,000 seconds. Time intervals of a communications resource may be organized according to radio frames each having a duration of 10 milliseconds (ms), where the frame period may be expressed as T_{f}=307,200 Tₛ. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases, a subframe may be the smallest scheduling unit of the wireless communications system 100 and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

As described herein, in some wireless communications systems, a UE may communicate with a base station using one or more beams. In such systems, a UE may include multiple antenna modules (or RFICs) used to generate the beams for communicating with a base station. However, the power consumption associated with operating RFICs for mmW radio frequency (RF) communications may be high. For example, in systems supporting beamformed communications (e.g., NR), mmW RF power may be approximately 75% of the overall power (e.g., as opposed to 30% in systems not employing beamformed communications (e.g., LTE)). Accordingly, it may be appropriate for a UE to transition unused RFICs to a power saving mode and transition an RFIC back to an active mode when the RFIC is to be used.

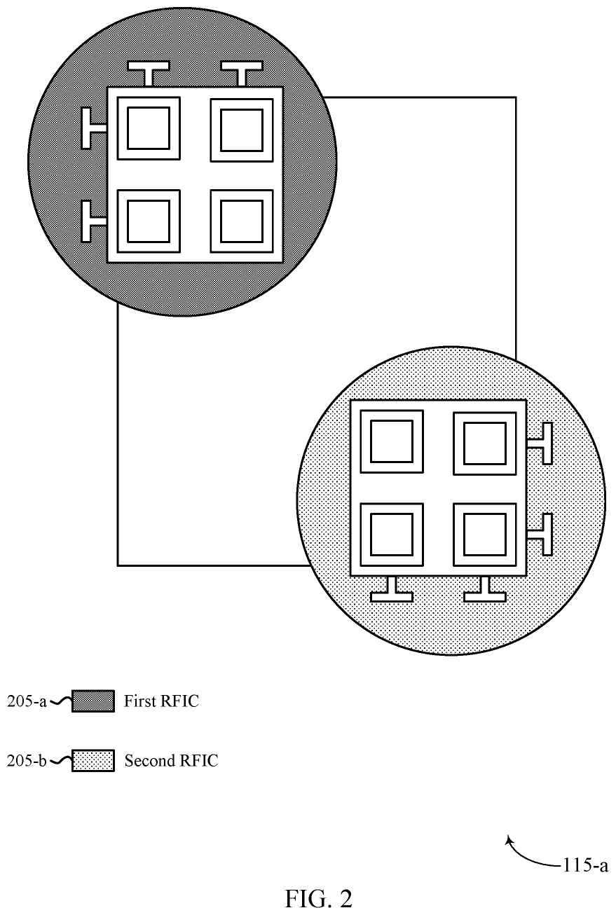

FIG. 2 illustrates an example of a UE 115-a with multiple RFICs in accordance with aspects of the present disclosure. As depicted herein an antenna module may be referred to as or may include an RFIC. In FIG. 2, a first RFIC 205-a may be located at the front of the UE 115-a and a second RFIC 205-b may be located at the back of the UE 115-a. In some cases, when the first RFIC 205-a is being used, the second RFIC 205-b may be unused, and UE 115-a may transition the second RFIC 205-b to a power saving mode to limit power consumption. Similarly, in some cases, when the second RFIC 205-b is being used, the first RFIC 205-a may be unused, and UE 115-a may transition the first RFIC 205-a to a power saving mode to limit power consumption. Some wireless communications systems may support multiple power saving modes each associated with a certain amount of power savings and a latency for transitioning an RFIC to and from the power saving mode. Table 1 provides examples of power modes of an RFIC.

TABLE 1
RFIC Power Modes

| | Duration for | Duration for | |
|---|---|---|---|
| | transition from | transition from | |
| | listed mode | active mode | RFIC |
| | to active mode | to listed mode | Current Adder |
| Mode | (in ms) | (in ms) | (in mA) |
| Active: | N/A | N/A | 92.3 |
| 1-element beam | | | |
| 0-element beam | N/A | N/A | 23 |
| Deep | 0.01 | 0.005 | 6.8 |
| 0-element beam | | | |
| Light Retention | 0.15 | 0.15 | 1 |
| Retention | 1.2 | 1.2 | 0.147 |

As shown in Table 1, a power mode associated with high power savings may also be associated with high latency for transitioning an RFIC to the power mode and back to an active mode. For example, a UE 115 may use a current adder of 23 milliamps (mA) to operate an RFIC in a zero-element beam (ZEB) mode while the latency associated with transitioning the RFIC to or from the ZEB mode may be negligible, and the UE 115 may use a current adder of 0.147 mA to operate an RFIC in a retention mode while the latency associated with transitioning the RFIC to or from the retention mode may be 1.2 ms. The different power modes defined above may be useful for antenna modules (or RFICs) in different scenarios. However, conventional techniques for managing the power modes of RFICs may be deficient (e.g., may not consider the inputs from components which may use the RFICs for communications). Wireless communications system 100 may support efficient techniques for managing antenna modules (such as, RFICs) to maximize power savings and minimize latency.

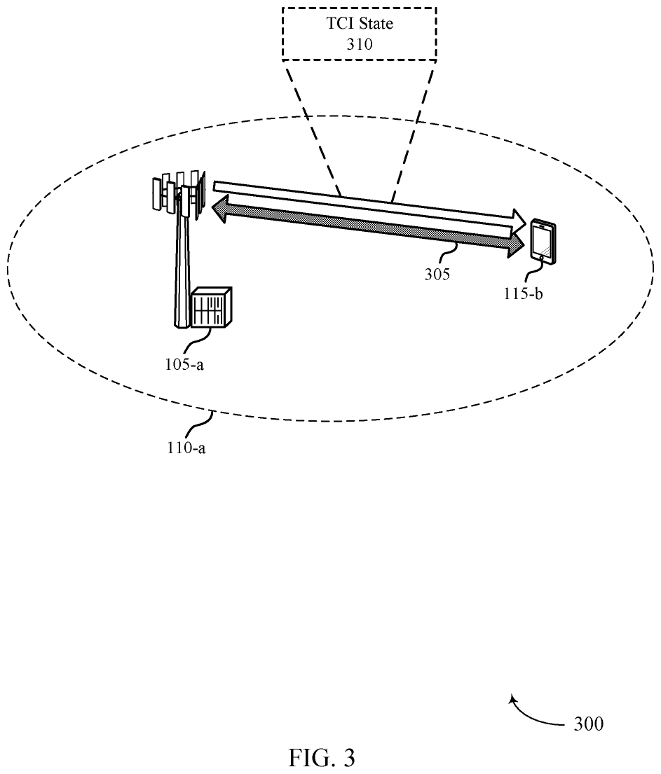

FIG. 3 illustrates an example of a wireless communications system 300 that supports mmW antenna module control in accordance with aspects of the present disclosure. Wireless communications system 300 includes base station 105-a, which may be an example of a base station 105 described with reference with FIG. 1. Wireless communications system 300 also includes UE 115-b, which may be an example of a UE 115 described with reference to FIG. 1. Base station 105-a may provide communication coverage for a respective coverage area 110-a, which may be an example of a coverage area 110 described with reference to FIG. 1. Base station 105-a may communicate with UE 115-b on resources of a carrier 305. It may be understood that an antenna module may be referred to as an RFIC and may be used interchangeably.

In the example of FIG. 3, base station 105-a may identify a serving beam to use for communicating with UE 115-b (e.g., for a control or data transmission), and base station 105-a may transmit an indication of an active transmission configuration indication (TCI) state 310 corresponding to the serving beam to UE 115-b. Accordingly, UE 115-b may identify an antenna module (such as, RFIC) to be used as an active antenna module for communicating with the base station 105-a in accordance with the active TCI state or the base station serving beam. In some examples, an active RFIC may be used to generate a receive beam (e.g., a receive beam associated with a highest quality) for receiving data or control information from base station 105-a transmitted on the serving beam. Alternatively, the active RFIC may be used to generate a transmit beam (e.g., a transmit beam associated with a highest quality) for transmitting data or control information to base station 105-a to be received by the base station 105-a on the serving beam.

After identifying the active antenna module (or RFIC), UE 115-b may transition each of the remaining antenna modules to a power saving mode to limit power consumption at the UE 115-b. However, it may also be appropriate to ensure that UE 115-b is able to transition an RFIC in a power saving mode to an active mode given a particular leading time when the RFIC is to be used for communications. That is, the UE 115-b may ensure that an RFIC is in an active mode when UE 115-b is scheduled for communications using the RFIC or to ensure that the latency due to transitioning an RFIC to an active mode when UE 115-b is scheduled for communications using the RFIC is minimal. As discussed above, however, conventional techniques for managing the power modes of RFICs may be deficient (e.g., may not consider the inputs from components which may use the RFICs for communications).

Wireless communications system 300 may support efficient techniques for managing antenna module (such as, RFICs) to maximize power savings and minimize latency. In particular, UE 115-b may support techniques for transitioning remaining antenna modules (e.g., RFICs not in an active mode) to an appropriate power mode such that antenna modules to be used for subsequent communications may be transitioned to an active mode before or in time for the communications. In some examples, RFICs that may be used for subsequent communications or communications within a leading time may be categorized as candidate RFICs and may be transitioned to power modes associated with lower latency for transitioning the RFICs back to an active mode, and RFICs that may not be used for subsequent communications or communications within a leading time may be categorized as unused RFICs and may be transitioned to power modes associated with higher power savings.

As mentioned above, UE 115-b may categorize antenna module (or RFICs) that may be used for subsequent communications or communications within a leading time as candidate RFICs. In some cases, UE 115-b may identify the beams that may be used for subsequent communications or communications within a leading time based on beam measurements. For example, UE 115-b may perform beam measurements and may identify beams with a higher quality than a current beam generated by an active RFIC. Since beams with a higher quality than a current beam generated by an active RFIC may be used for subsequent communications or communications within a leading time (e.g., as described in further detail below), UE 115-b may categorize or identify the RFICs used to generate these beams as candidate RFICs. In some cases, in addition to the categorization of candidate RFICs described above, a candidate RFIC may further be categorized as a first type of candidate RFIC or a second type of candidate RFIC.

In one example, antenna modules (such as, RFICs) used to generate beams (e.g., UE receive or transmit beams) having a higher quality than a current beam (e.g., a current UE receive or transmit beam) for a serving beam of a base station 105-a (e.g., a base station transmit or receive beam) may be categorized as a first type of RFIC. That is, RFICs used to generate UE beams having a higher quality than a current beam generated by an active RFIC for an active TCI state 310 may be categorized as a first type of RFIC. Accordingly, if UE 115-b performs an autonomous UE beam switch to a new beam to guarantee the best performance for communicating with a base station 105-a for an active TCI state 310, the UE 115-b may be able to transition an RFIC used to generate the new beam (e.g., a non-serving RFIC) to an active mode within a leading time (e.g., when the original serving UE beam is at the edge of the serving RFIC). In some cases, UE 115-b may prepare the new beam (e.g., a receive beam) in the adjacent non-serving RFIC for training in a CSI-RS P3 beam management procedure.

In another example, antenna modules (such as, RFICs) used to generate beams (e.g., UE receive or transmit beams) having a higher quality than a current beam (e.g., a current UE receive or transmit beam) for a different serving beam from a serving beam of a base station 105-a (e.g., a base station transmit or receive beam) may be categorized as a second type of RFIC. That is, RFICs used to generate UE beams having a higher quality than a current beam generated by an active RFIC for a TCI state different from an active TCI state 310 may be categorized as a second type of RFIC. Accordingly, if base station 105-a initiates a beam switch at the base station to a new active TCI state or new serving beam (e.g., via a MAC-CE with a leading time of 2 ms), the UE 115-b may be able to transition an RFIC used to generate a receive beam (e.g., associated with a highest quality of the receive beams) to an active mode within a leading time (e.g., 2 ms). In this example, the UE 115-b may report beams (e.g., in a P1 beam management procedure) of active and candidate RFICs to ensure that the UE 115-b may have sufficient time to transition an RFIC to an active mode (e.g., when the UE reports a base station beam whose best UE beam is in a non-active RFIC). In some cases, base station 105-a may pre-train the base station beam in a P2 or P3 beam management procedure before switching to an active TCI state corresponding to the base station beam.

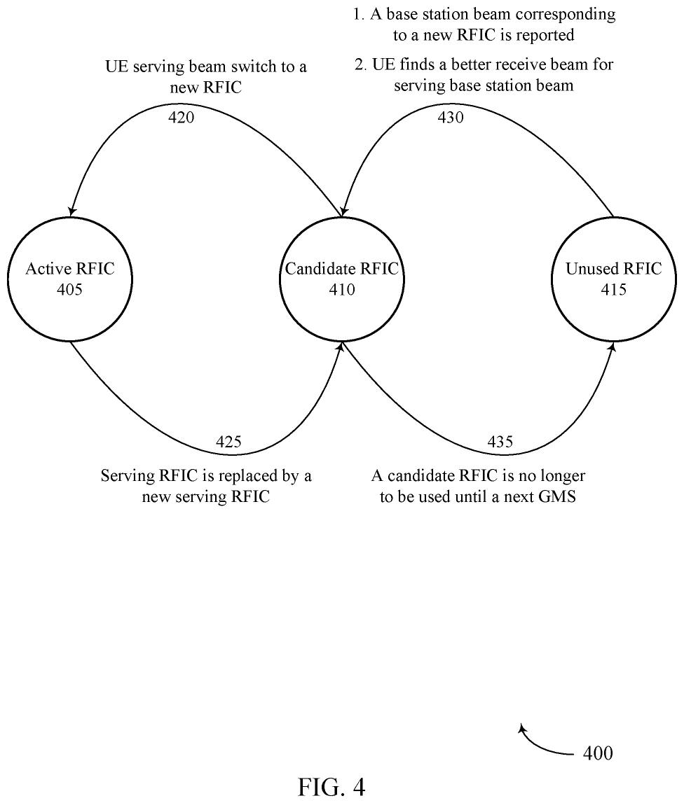

FIG. 4 illustrates an example of a state diagram 400 in accordance with aspects of the present disclosure. Specifically, FIG. 4 provides scenarios where a UE 115 may transition an RFIC to be an active RFIC 405, candidate RFIC 410, or unused RFIC 415. As depicted herein, an antenna module may be referred to as an RFIC and may be used interchangeably. In the example of FIG. 4, an RFIC categorized as an active RFIC 405 (e.g., a serving RFIC) may be replaced by a candidate RFIC 410 (e.g., a new serving RFIC). For instance, when there is a UE serving beam switch, a candidate RFIC 410 may be transitioned 420 to be a replacement active RFIC 405, and an active RFIC 405 may be transitioned 425 to be a candidate RFIC 410. Further, a candidate RFIC 410 may be transitioned 435 to be an unused RFIC 415 (e.g., when the candidate RFIC 410 is no longer to be used until a next global messaging service (GMS)). In addition, an unused RFIC 415 may be transitioned 430 to be a candidate RFIC 410. For instance, when a base station beam corresponding to a new RFIC is reported by a UE as having good quality (e.g., in a beam report), an unused RFIC 415 used to generate, for example, a best receive beam for receiving signals from the base station beam may be transitioned 430 to be a candidate RFIC 410. Additionally, if a UE identifies a better receive beam for receiving signals from a serving base station beam, an unused RFIC 415 used to generate the receive beam may be transitioned 430 to be a candidate RFIC 410.

The above changes in the categorization of RFICs as active RFICs 405 (or active antenna modules), candidate RFICs 410 (or candidate antenna modules), or unused RFICs 415 (or unused antenna modules) may occur when a UE 115 identifies updated beam measurements. As discussed with reference to FIG. 3, a UE 115 may first identify a UE beam (e.g., receive or transmit beam) to use for communicating with a base station 105 on a base station serving beam in accordance with a TCI state. The UE beam may correspond to a UE beam associated with a highest quality for communicating with the base station serving beam and may be identified in a beam management procedure. The UE may then categorize an RFIC used to generate the UE beam as an active RFIC 405 (e.g., where the active RFIC 405 may correspond to one active TCI state and other RFICs may also be categorized as active RFICs 405 for other active TCI states).

For each subsequent periodical beam management procedure (e.g., P1 beam management procedure including the transmission and reception of SSBs and/or CSI-RSs), the UE 115 may measure the quality of UE beams against different base station beams, and the UE 115 may categorize RFICs used to generate UE beams having higher qualities (e.g., higher RSRPs) than a current UE beam as candidate RFICs 410. That is, the UE 115 may update beam measurement results based on a beam management procedure and may change the categorization of remaining RFICs (e.g., RFICs not in an active mode) as either candidate RFICs 410 or unused RFICs 415 based on the updated beam measurements.

For instance, if a metric for a UE beam generated by an RFIC used to receive a transmission on a base station beam (e.g., an SSB transmission) is greater than a key performance indicator (such as, RSRP) on a serving UE beam used to receive a transmission on a serving base station beam plus a threshold amount, the RFIC may be categorized as a candidate RFIC 410. Further, if a metric for a UE beam generated by an RFIC used to receive a transmission on a serving base station beam (e.g., corresponding to an active TCI state) is greater than the RSRP on a serving UE beam used to receive a transmission on a serving base station beam plus a threshold amount, the RFIC may be categorized as a type-1 candidate RFIC 410. Alternatively, if a metric for a UE beam generated by an RFIC used to receive a transmission on a base station beam different from a serving base station beam (e.g., corresponding to a non-active TCI state) is greater than the RSRP on a serving UE beam used to receive a transmission on a serving base station beam plus a threshold amount, the RFIC may be categorized as a type-2 candidate RFIC 410. The algorithm described above for categorizing RFICs may correspond to the following pseudocode:
metric(RFIC)=Collapse_{SSB,RxB on one RFIC} RSRP(SSB, RxB)
If metric(RFICₓ)>RSRP on serving+PHyst
   Then RFIC_{X} is a candidate phaser
End
   RFICₓ is a type-1 candidate RFIC if the RFIC metric corresponds to the active TCI
   RFICₓ is a type-2 candidate RFIC otherwise
   where Collapse_{SSB,RxB on one RFIC} RSRP(SSB, RxB) is a per-RFIC metric which corresponds to the collapsed RSRP across all detected SSBs and all received beams located in one particular RFIC.

Alternatively, the algorithm described above for categorizing antenna modules (or RFICs) may correspond to the following pseudocode:
metric(module)=Collapse_{SSB,RxB on one module} KPI_metric(SSB, RxB)
If metric(moduleₓ) is good compared to metric(active module)
Then moduleₓ is a candidate module set until reaching MAX_CAND_MODULE_LIMIT
End
   where Collapse_{SSB,RxB on one module} KPI_metric(SSB, RxB) is a per-RFIC metric which corresponds to a key performance indicator (e.g., RSRP, reference signal received quality (RSRQ), signal to noise ratio, etc.) across all detected SSBs and all received beams located in one particular RFIC.

As described below in further detail below, the active RFICs 405 and candidate RFICs 410 may be enabled to receive potential aperiodic transmissions on aperiodic resources, prepare beam reports, or to facilitate a beam switch for PDSCH or PDCCH transmissions indicated by a base station 105, and the unused RFICs 415 may be transitioned to a power mode associated with low power consumption (e.g., a light retention or retention power mode). Further, an active RFIC 405 used to serve traffic or control channels (e.g., generate a beam for communications on traffic or control channels) may be in an active mode when being used, a ZEB mode when not used in an upcoming symbol, and a DZEB mode when not used in an upcoming slot. The short power mode transition time of ZEB and DZEB modes may be sufficient to satisfy the strict timeline (e.g., with a leading time of two slots) of DCI triggering (e.g., for the case of multiple active TCI states). The candidate RFIC may be in a low-power mode for beam management (such as, beam report, beam switch, etc.). Although the low-power mode may consume more power than retention, the low-power mode has shorted transition time.

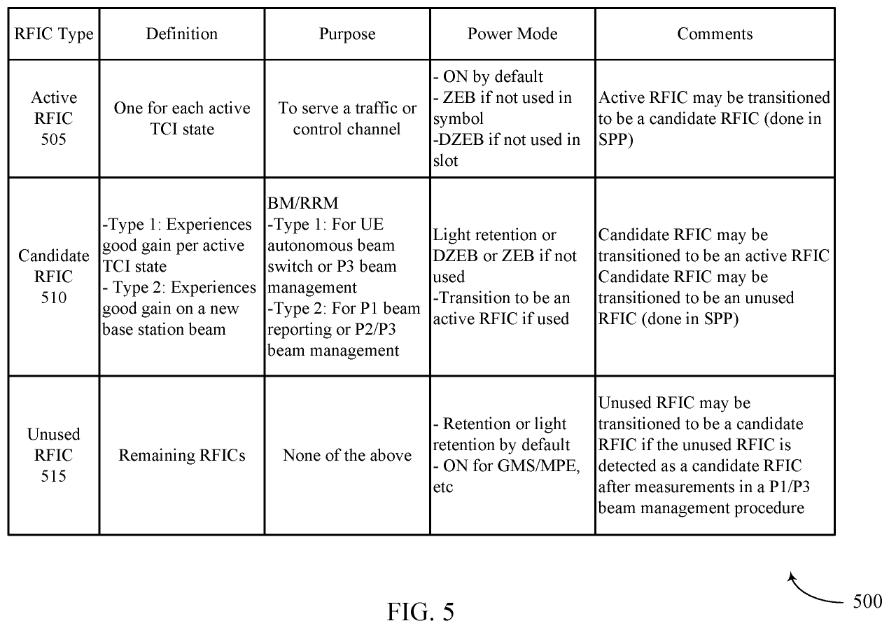

FIG. 5 illustrates a table 500 that provides further details for active RFICs 505, candidate RFICs 510, and unused RFICs 515 in accordance with aspects of the present disclosure.

In the examples described herein, a UE 115 may identify (or categorize) RFICs used to generate beams with a higher quality than a current beam as candidate RFICs 510 such that the UE 115 may be able to transition these RFICs to an active mode in a threshold amount of time, and the UE 115 may categorize other RFICs as unused RFICs 515. The categorization of RFICs may be based on whether the RFICs are to be used by components or entities (e.g., referred to as clients of the RFICs) for communications in a leading time (e.g., a threshold amount of time). One example of such components or entities may be a beam management component or entity which may use RFICs to generate beams to transmit or receive control or data transmissions, perform beam search and beam measurement, report beam measurement results to base station 105, and prepare for a potential beam switch. Another example of such components or entities may be a maximum permittable emission (MPE) scheduler which may use RFICs to perform MPE scanning almost periodically to check if certain sub-arrays or RFICs or beams are blocked by human tissue.

In some aspects, these components or entities may not have to use an RFIC for communications in a threshold amount of time. Accordingly, a UE 115 may have the option of categorizing the RFIC as an unused RFIC 515. In one example, a beam management component or entity may determine the RFIC to use in each symbol (e.g., to receive an SSB or CSI-RS) with sufficient leading time to be able to transition the RFIC from any power saving mode (e.g., a retention mode) to an active mode. In another example, an MPE scheduler may determine the RFIC to use in each symbol with sufficient leading time to be able to transition the RFIC from any power saving mode (e.g., a retention mode) to an active mode. Thus, in such aspects, a UE 115 may categorize the RFICs (e.g., inactive RFICs) as unused RFICs 515 and may transition these RFICs to power modes associated with high power savings.

In other aspects, these components or entities may have to use an RFIC for communications in a threshold amount of time. Accordingly, a UE 115 may categorize the RFIC as a candidate RFIC 510. In one example, a UE 115 may be scheduled in DCI with a short (e.g., 28-symbol) leading time to receive an aperiodic CSI-RS (e.g., in a P2 beam management procedure), and may transition an RFIC to an active mode quickly to receive the aperiodic CSI-RS. Accordingly, RFICs that may be used to receive aperiodic CSI-RSs (e.g., RFICs used to generate beams with a higher quality than a current beam) may be categorized as candidate RFICs 510. In another example, a UE 115 may be scheduled to transmit a periodic or aperiodic beam report, and may transition an RFIC to an active mode quickly to transmit the beam report. Accordingly, RFICs that may be used to transmit the beam report (e.g., RFICs used to generate beams with a higher quality than a current beam) may be categorized as candidate RFICs 510.

In yet another example, a UE 115 may initiate an autonomous beam switch from a beam generated by an active RFIC 505 to a beam generated by another RFIC, and may transition the other RFIC to an active mode quickly to continue communications with a base station 105. Accordingly, RFICs that may be used to generate beams to which the UE 115 may switch (e.g., RFICs used to generate beams with a higher quality than a current beam) may be categorized as candidate RFICs 510. In yet another example, a UE 115 may receive an indication (e.g., in DCI or a MAC-CE with a short (e.g., 2 ms) leading time) from a base station 105 to switch from a beam generated by an active RFIC 505 to a beam generated by another RFIC (e.g., for a PDCCH or PUCCH transmission or for a single TCI or multi-TCI PDSCH or PUSCH transmission), and may transition the other RFIC to an active mode quickly to continue communications with a base station 105. Accordingly, RFICs that may be used to generate beams to which the UE 115 may switch (e.g., RFICs used to generate beams with a higher quality than a current beam) may be categorized as candidate RFICs 510.

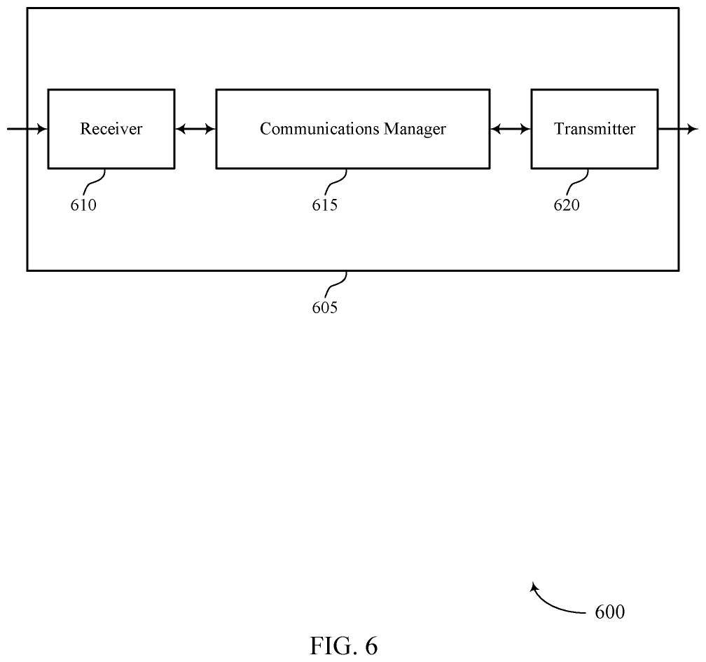

FIG. 6 shows a block diagram 600 of a device 605 that supports mmW antenna module control in accordance with aspects of the present disclosure. The device 605 may be an example of aspects of a UE 115 as described herein. The device 605 may include a receiver 610, a communications manager 615, and a transmitter 620. The device 605 may also include a processor. Each of these components may be in communication with one another (e.g., via one or more buses).

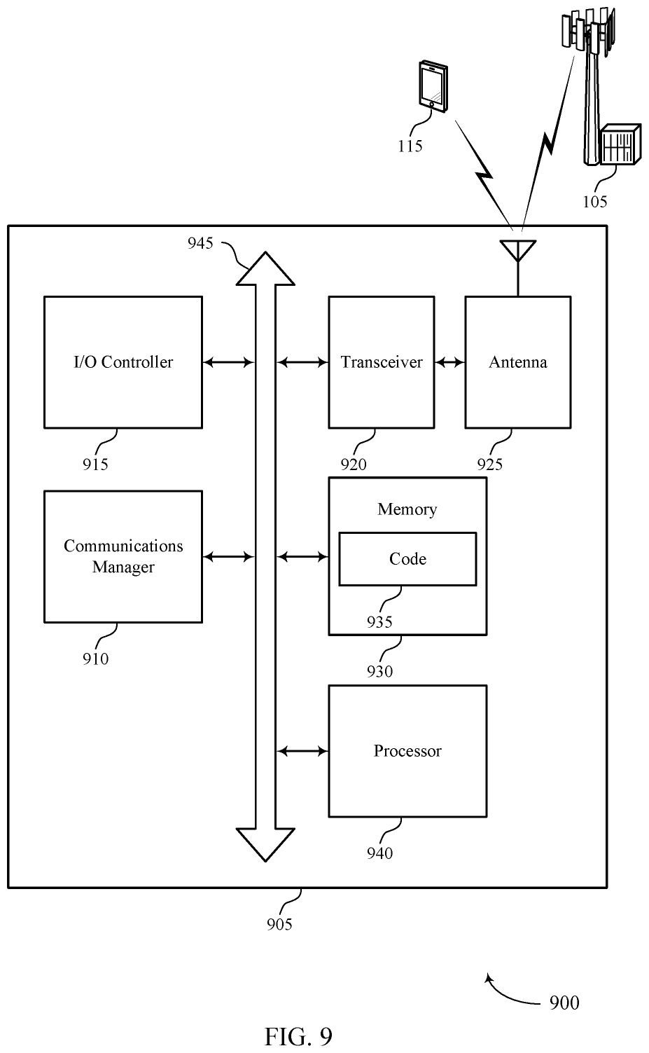

The receiver 610 may receive information such as packets, user data, or control information associated with various information channels (e.g., control channels, data channels, and information related to mmW antenna module control). Information may be passed on to other components of the device 605. The receiver 610 may be an example of aspects of the transceiver 920 described with reference to FIG. 9. The receiver 610 may utilize a single antenna or a set of antennas.

The communications manager 615 may identify an active TCI state or serving beam of a base station to be used for one or more scheduled transmissions, identify an antenna module at the UE to be used as an active antenna module for receipt of the one or more scheduled transmissions via the active TCI state or serving beam, identify one or more remaining antenna modules at the UE as either candidate antenna modules for potentially replacing the active antenna module within a leading time or as unused antenna modules, and receive the one or more scheduled transmissions via the active antenna module or via a replacement active antenna module selected from the candidate antenna modules. The communications manager 615 may be an example of aspects of the communications manager 910 described herein.

The communications manager 615, or its sub-components, may be implemented in hardware, code (e.g., software or firmware) executed by a processor, or any combination thereof. If implemented in code executed by a processor, the functions of the communications manager 615, or its sub-components may be executed by a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure.

The communications manager 615, or its sub-components, may be physically located at various positions, including being distributed such that portions of functions are implemented at different physical locations by one or more physical components. In some examples, the communications manager 615, or its sub-components, may be a separate and distinct component in accordance with various aspects of the present disclosure. In some examples, the communications manager 615, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 620 may transmit signals generated by other components of the device 605. In some examples, the transmitter 620 may be collocated with a receiver 610 in a transceiver module. For example, the transmitter 620 may be an example of aspects of the transceiver 920 described with reference to FIG. 9. The transmitter 620 may utilize a single antenna or a set of antennas.

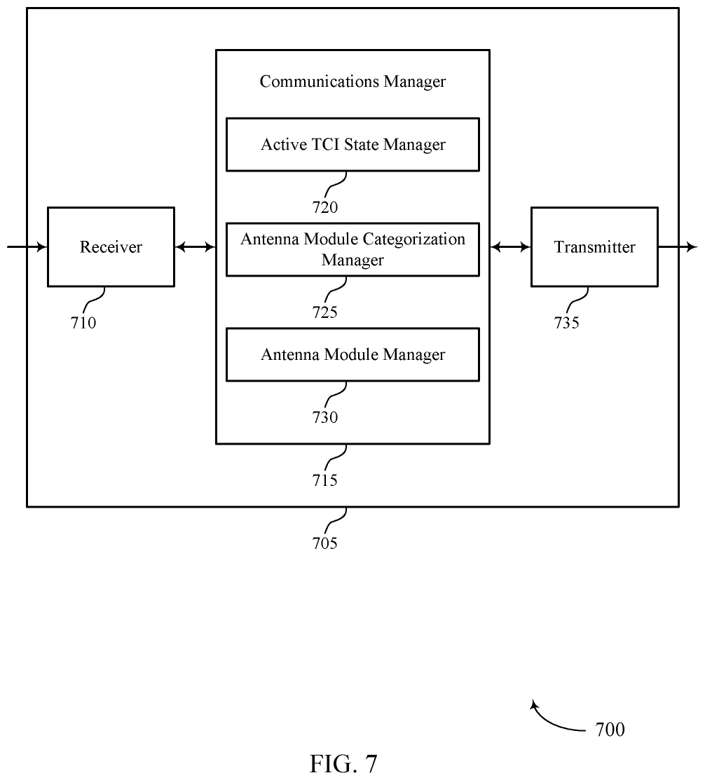

FIG. 7 shows a block diagram 700 of a device 705 that supports mmW antenna module control in accordance with aspects of the present disclosure. The device 705 may be an example of aspects of a device 605, or a UE 115 as described herein. The device 705 may include a receiver 710, a communications manager 715, and a transmitter 735. The device 705 may also include a processor. Each of these components may be in communication with one another (e.g., via one or more buses).

The receiver 710 may receive information such as packets, user data, or control information associated with various information channels (e.g., control channels, data channels, and information related to mmW antenna module control). Information may be passed on to other components of the device 705. The receiver 710 may be an example of aspects of the transceiver 920 described with reference to FIG. 9. The receiver 710 may utilize a single antenna or a set of antennas.

The communications manager 715 may be an example of aspects of the communications manager 615 as described herein. The communications manager 715 may include an active TCI state manager 720, an antenna module categorization manager 725, and an antenna module manager 730. The communications manager 715 may be an example of aspects of the communications manager 910 described herein.

The active TCI state manager 720 may identify an active TCI state or serving beam of a base station to be used for one or more scheduled transmissions. The antenna module categorization manager 725 may identify an antenna module at the UE to be used as an active antenna module for receipt of the one or more scheduled transmissions via the active TCI state or serving beam and identify one or more remaining antenna modules at the UE as either candidate antenna modules for potentially replacing the active antenna module within a leading time or as unused antenna modules. The antenna module manager 730 may receive the one or more scheduled transmissions via the active antenna module or via a replacement active antenna module selected from the candidate antenna modules.

The transmitter 735 may transmit signals generated by other components of the device 705. In some examples, the transmitter 735 may be collocated with a receiver 710 in a transceiver module. For example, the transmitter 735 may be an example of aspects of the transceiver 920 described with reference to FIG. 9. The transmitter 735 may utilize a single antenna or a set of antennas.

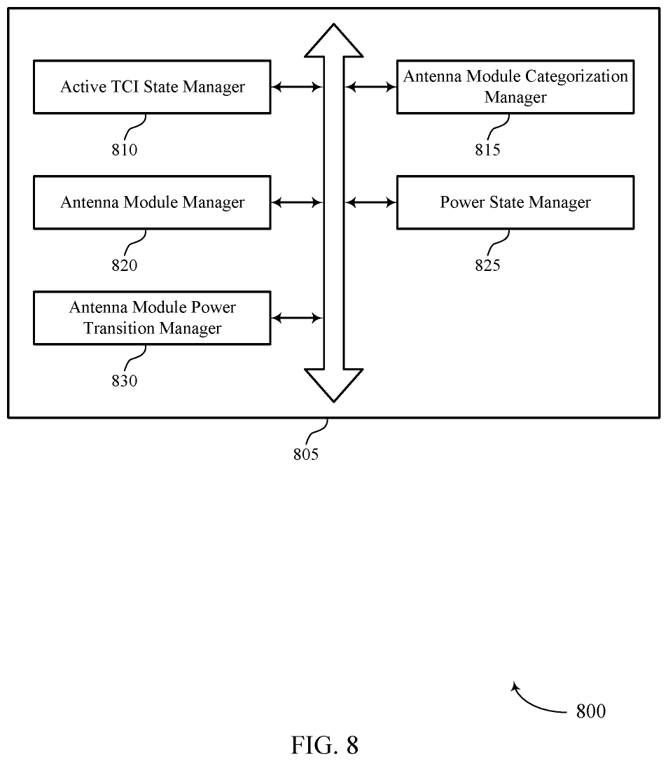

FIG. 8 shows a block diagram 800 of a communications manager 805 that supports mmW antenna module control in accordance with aspects of the present disclosure. The communications manager 805 may be an example of aspects of a communications manager 615, a communications manager 715, or a communications manager 910 described herein. The communications manager 805 may include an active TCI state manager 810, an antenna module categorization manager 815, an antenna module manager 820, a power state manager 825, and an antenna module power transition manager 830. Each of these modules may communicate, directly or indirectly, with one another (e.g., via one or more buses).

The active TCI state manager 810 may identify an active TCI state or serving beam of a base station to be used for one or more scheduled transmissions. In some examples, the active TCI state manager 810 may identify the serving beam of the base station to be used for one or more scheduled transmissions based on the active TCI state. The antenna module categorization manager 815 may identify an antenna module at the UE to be used as an active antenna module for receipt of the one or more scheduled transmissions via the active TCI state or serving beam. In some examples, the antenna module may include an RFIC. In some examples, the antenna module categorization manager 815 may identify (or categorize) one or more remaining antenna modules at the UE as either candidate antenna modules for potentially replacing the active antenna module within a leading time or as unused antenna modules.

In some examples, the antenna module categorization manager 815 may identify an antenna module of the remaining antenna modules at the UE that has a stronger key performance indicator with respect to a configured TCI state or beam than the active antenna module has with respect to the configured TCI state or beam. In some cases, the key performance indicator includes at least one of a RSRP, a RSRQ, a signal to noise ratio, or a combination thereof. In some cases, the configured TCI state includes the active transmission configuration indication state and the beam includes a serving beam In some examples, the antenna module categorization manager 815 may categorize the antenna module as a first type of candidate antenna module. In some examples, the antenna module categorization manager 815 may identify an antenna module of the remaining antenna modules at the UE that has a stronger RSRP measurement with respect to a different TCI state or beam other than the active TCI state or serving beam than the active antenna module has with respect to the active TCI state or serving beam. In some examples, the antenna module categorization manager 815 may categorize the antenna module as a second type of candidate antenna module.

The antenna module manager 820 may receive the one or more scheduled transmissions via the active antenna module or via a replacement active antenna module selected from the candidate antenna modules. The power state manager 825 may maintain the active antenna module at an active power state. In some examples, the power state manager 825 may transition the unused antenna modules to an inactive power state. In some examples, the power state manager 825 may transition the candidate antenna modules to a power state that is in between the active power state and the inactive power state, where power states associated with lower power consumption are associated with higher latency for power state transition.

The antenna module power transition manager 830 may determine that the active antenna module is to be replaced by one of the candidate antenna modules. In some examples, the antenna module power transition manager 830 may transition the active antenna module to be a candidate antenna module. In some examples, the antenna module power transition manager 830 may transition the one of the candidate antenna modules to be a replacement active antenna module. In some examples, the antenna module power transition manager 830 may determine that the one of the candidate antenna modules has a stronger received signal received power measurement with respect to the active TCI state or serving beam than the active antenna module has with respect to the active TCI state or serving beam.

In some examples, the antenna module power transition manager 830 may determine that the one of the candidate antenna modules has a stronger received signal received power measurement with respect to a different TCI state or beam other than the active TCI state or serving beam than the active antenna module has with respect to the active TCI state or serving beam. In some examples, the antenna module power transition manager 830 may determine that at least one of the candidate antenna modules will not be used to replace the active antenna module within the leading time. In some examples, the antenna module power transition manager 830 may transition the at least one of the candidate antenna modules to be an unused antenna module based on the determination. In some examples, the antenna module power transition manager 830 may determine that at least one of the unused antenna modules is potentially to be used as a replacement antenna module to the active antenna module within the leading time. In some examples, the antenna module power transition manager 830 may transition the at least one of the unused antenna modules to be a candidate antenna module based on the determination.

FIG. 9 shows a diagram of a system 900 including a device 905 that supports mmW antenna module control in accordance with aspects of the present disclosure. The device 905 may be an example of or include the components of device 605, device 705, or a UE 115 as described herein. The device 905 may include components for bi-directional voice and data communications including components for transmitting and receiving communications, including a communications manager 910, an I/O controller 915, a transceiver 920, an antenna 925, memory 930, and a processor 940. These components may be in electronic communication via one or more buses (e.g., bus 945).

The communications manager 910 may identify an active TCI state or serving beam of a base station to be used for one or more scheduled transmissions, identify an antenna module at the UE to be used as an active antenna module for receipt of the one or more scheduled transmissions via the active TCI state or serving beam, identify one or more remaining antenna modules at the UE as either candidate antenna modules for potentially replacing the active antenna module within a leading time or as unused antenna modules, and receive the one or more scheduled transmissions via the active antenna module or via a replacement active antenna module selected from the candidate antenna modules.

The I/O controller 915 may manage input and output signals for the device 905. The I/O controller 915 may also manage peripherals not integrated into the device 905. In some cases, the I/O controller 915 may represent a physical connection or port to an external peripheral. In some cases, the I/O controller 915 may utilize an operating system such as iOS®, ANDROID®, MS-DOS®, MS-WINDOWS®, OS/2®, UNIX®, LINUX®, or another known operating system. In other cases, the I/O controller 915 may represent or interact with a modem, a keyboard, a mouse, a touchscreen, or a similar device. In some cases, the I/O controller 915 may be implemented as part of a processor. In some cases, a user may interact with the device 905 via the I/O controller 915 or via hardware components controlled by the I/O controller 915.

The transceiver 920 may communicate bi-directionally, via one or more antennas, wired, or wireless links as described herein. For example, the transceiver 920 may represent a wireless transceiver and may communicate bi-directionally with another wireless transceiver. The transceiver 920 may also include a modem to modulate the packets and provide the modulated packets to the antennas for transmission, and to demodulate packets received from the antennas.

In some cases, the wireless device may include a single antenna 925. However, in some cases, the device may have more than one antenna 925, which may be capable of concurrently transmitting or receiving multiple wireless transmissions.

The memory 930 may include random access memory (RAM) and read only memory (ROM). The memory 930 may store computer-readable, computer-executable code 935 including instructions that, when executed, cause the processor to perform various functions described herein. In some cases, the memory 930 may contain, among other things, a basic input/output system (BIOS) which may control basic hardware or software operation such as the interaction with peripheral components or devices.

The processor 940 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In other cases, a memory controller may be integrated into the processor 940. The processor 940 may be configured to execute computer-readable instructions stored in a memory (e.g., the memory 930) to cause the device 905 to perform various functions (e.g., functions or tasks supporting mmW antenna module control).

The code 935 may include instructions to implement aspects of the present disclosure, including instructions to support wireless communications. The code 935 may be stored in a non-transitory computer-readable medium such as system memory or other type of memory. In some cases, the code 935 may not be directly executable by the processor 940 but may cause a computer (e.g., when compiled and executed) to perform functions described herein.

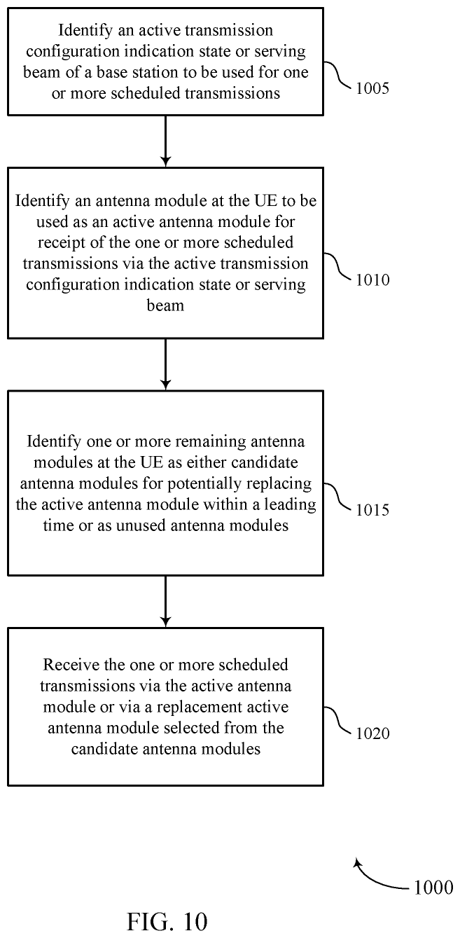

FIG. 10 shows a flowchart illustrating a method 1000 that supports mmW antenna module control in accordance with aspects of the present disclosure. The operations of method 1000 may be implemented by a UE 115 or its components as described herein. For example, the operations of method 1000 may be performed by a communications manager as described with reference to FIGS. 6-9. In some examples, a UE may execute a set of instructions to control the functional elements of the UE to perform the functions described herein. Additionally, or alternatively, a UE may perform aspects of the functions described herein using special-purpose hardware.

At 1005, the UE may identify an active TCI state or serving beam of a base station to be used for one or more scheduled transmissions. The operations of 1005 may be performed according to the methods described herein. In some examples, aspects of the operations of 1005 may be performed by an active TCI state manager as described with reference to FIGS. 6-9.

At 1010, the UE may identify an antenna module at the UE to be used as an active antenna module for receipt of the one or more scheduled transmissions via the active TCI state or serving beam. The operations of 1010 may be performed according to the methods described herein. In some examples, aspects of the operations of 1010 may be performed by an antenna module categorization manager as described with reference to FIGS. 6-9.

At 1015, the UE may identify one or more remaining antenna modules at the UE as either candidate antenna modules for potentially replacing the active antenna module within a leading time or as unused antenna modules. The operations of 1015 may be performed according to the methods described herein. In some examples, aspects of the operations of 1015 may be performed by an antenna module categorization manager as described with reference to FIGS. 6-9.

At 1020, the UE may receive the one or more scheduled transmissions via the active antenna module or via a replacement active antenna module selected from the candidate antenna modules. The operations of 1020 may be performed according to the methods described herein. In some examples, aspects of the operations of 1020 may be performed by an antenna module manager as described with reference to FIGS. 6-9.

It should be noted that the methods described herein describe possible implementations, and that the operations and the steps may be rearranged or otherwise modified and that other implementations are possible. Further, aspects from two or more of the methods may be combined.

Aspects of the following examples may be combined with any of the previous examples or aspects described herein.

### Example 1

A method of wireless communications comprising identifying an active transmission configuration indication state or serving beam of a base station to be used for one or more scheduled transmissions, identifying an antenna module at the UE to be used as an active antenna module for receipt of the one or more scheduled transmissions via the active transmission configuration indication state or serving beam, identifying one or more remaining antenna modules at the UE as either candidate antenna modules for potentially replacing the active antenna module within a leading time or as unused antenna modules, and receiving the one or more scheduled transmissions via the active antenna module or via a replacement active antenna module selected from the candidate antenna modules.

### Example 2

The method of example 1, further comprising: maintaining the active antenna module at an active power state, transitioning the unused antenna modules to an inactive power state, and transitioning the candidate antenna modules to a power state that is in between the active power state and the inactive power state, where power states associated with lower power consumption are associated with higher latency for power state transition.

### Example 3

The method of examples 1 and 2, further comprising: determining that the active antenna module is to be replaced by one of the candidate antenna modules, transitioning the active antenna module to be a candidate antenna module, and transitioning the one of the candidate antenna modules to be a replacement active antenna module.

### Example 4

The method of example 3, wherein determining that the active antenna module is to be replaced by the one of the candidate antenna modules comprises: determining that the one of the candidate antenna modules has a stronger key performance indicator with respect to a configured transmission configuration indication state or beam than the active antenna module has with respect to the configured transmission configuration indication state or beam.

### Example 5

The method of example 4, wherein the key performance indicator comprises at least one of a reference signal received power, a reference signal received quality, a signal to noise ratio, or a combination thereof.

### Example 6

The method of example 4, wherein the configured transmission configuration indication state comprises the active transmission configuration indication state and the beam comprises a serving beam.

### Example 7

The method of any of examples 1 to 6, further comprising: determining that at least one of the candidate antenna modules will not be used to replace the active antenna module within the leading time, and transitioning the at least one of the candidate antenna modules to be an unused antenna module based on the determination.

### Example 8

The method of any of examples 1 to 7, further comprising: determining that at least one of the unused antenna modules is potentially to be used as a replacement antenna module to the active antenna module within the leading time, and transitioning the at least one of the unused antenna modules to be a candidate antenna module based on the determination.

### Example 9

The method of any of examples 1 to 8, wherein identifying the one or more remaining antenna modules comprises: identifying an antenna module of the remaining antenna modules at the UE that has a stronger reference signal received power measurement with respect to the active transmission configuration indication state or serving beam than the active antenna module has with respect to the active transmission configuration indication state or serving beam, and identifying the antenna module as a first type of candidate antenna module.

### Example 10

The method of any of examples 1 to 9, wherein identifying the serving beam of the base station to be used for one or more scheduled transmissions comprises: identifying the serving beam of the base station to be used for one or more scheduled transmissions based on the active transmission configuration indication state.

### Example 11

The method of any of examples 1 to 10, wherein the antenna module comprises an RFIC.

### Example 12

apparatus for wireless communications comprising a processor; memory in electronic communication with the processor; and instructions stored in the memory and executable by the processor to cause the apparatus to perform a method of any of examples 1 to 11.

### Example 13

An apparatus comprising at least one means for performing a method of any of examples 1 to 11.

### Example 14

A non-transitory computer-readable medium storing code for wireless communications, the code comprising instructions executable by a processor to perform a method of any of examples 1 to 11.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned herein as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs with service subscriptions with the network provider. A small cell may be associated with a lower-powered base station, as compared with a macro cell, and a small cell may operate in the same or different (e.g., licensed, unlicensed) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication at a user equipment (UE), comprising:
identifying an active transmission configuration indication state or serving beam of a base station to be used for one or more scheduled transmissions;
identifying an antenna module at the UE to be used as an active antenna module for receipt of the one or more scheduled transmissions via the active transmission configuration indication state or serving beam;
identifying one or more remaining antenna modules at the UE as either candidate antenna modules for potentially replacing the active antenna module within a leading time or as unused antenna modules; and
receiving the one or more scheduled transmissions via the active antenna module or via a replacement active antenna module selected from the candidate antenna modules.

2. The method of claim 1, further comprising:
maintaining the active antenna module at an active power state;
transitioning the unused antenna modules to an inactive power state; and
transitioning the candidate antenna modules to a power state that is in between the active power state and the inactive power state, wherein power states associated with lower power consumption are associated with higher latency for power state transition.

3. The method of claim 1, further comprising:
determining that the active antenna module is to be replaced by one of the candidate antenna modules;
transitioning the active antenna module to be a candidate antenna module; and
transitioning the one of the candidate antenna modules to be a replacement active antenna module.

4. The method of claim 3, wherein determining that the active antenna module is to be replaced by the one of the candidate antenna modules comprises:
determining that the one of the candidate antenna modules has a stronger key performance indicator with respect to a configured transmission configuration indication state or beam than the active antenna module has with respect to the configured transmission configuration indication state or beam.

5. The method of claim 4, wherein the key performance indicator comprises at least one of a reference signal received power, a reference signal received quality, a signal to noise ratio, or a combination thereof.

6. The method of claim 4, wherein the configured transmission configuration indication state comprises the active transmission configuration indication state and the beam comprises a serving beam.

7. The method of claim 1, further comprising:
determining that at least one of the candidate antenna modules will not be used to replace the active antenna module within the leading time; and
transitioning the at least one of the candidate antenna modules to be an unused antenna module based at least in part on the determination.

8. The method of claim 1, further comprising:
determining that at least one of the unused antenna modules is potentially to be used as a replacement antenna module to the active antenna module within the leading time; and
transitioning the at least one of the unused antenna modules to be a candidate antenna module based at least in part on the determination.

9. The method of claim 1, wherein identifying the one or more remaining antenna modules comprises:
identifying an antenna module of the remaining antenna modules at the UE that has a stronger reference signal received power measurement with respect to the active transmission configuration indication state or serving beam than the active antenna module has with respect to the active transmission configuration indication state or serving beam; and
identifying the antenna module as a first type of candidate antenna module.

10. The method of claim 1, wherein identifying the serving beam of the base station to be used for one or more scheduled transmissions comprises:
identifying the serving beam of the base station to be used for one or more scheduled transmissions based at least in part on the active transmission configuration indication state.

11. The method of claim 1, wherein the antenna module comprises a radio frequency integrated circuit (RFIC).

12. An apparatus for wireless communication at a user equipment (UE), comprising:
a processor,
memory in electronic communication with the processor; and
instructions stored in the memory and executable by the processor to cause the apparatus to:
identify an active transmission configuration indication state or serving beam of a base station to be used for one or more scheduled transmissions;
identify an antenna module at the UE to be used as an active antenna module for receipt of the one or more scheduled transmissions via the active transmission configuration indication state or serving beam;
identify one or more remaining antenna modules at the UE as either candidate antenna modules for potentially replacing the active antenna module within a leading time or as unused antenna modules; and
receive the one or more scheduled transmissions via the active antenna module or via a replacement active antenna module selected from the candidate antenna modules.

13. The apparatus of claim 12, wherein the instructions are further executable by the processor to cause the apparatus to:
maintain the active antenna module at an active power state;
transition the unused antenna modules to an inactive power state; and
transition the candidate antenna modules to a power state that is in between the active power state and the inactive power state, wherein power states associated with lower power consumption are associated with higher latency for power state transition.

14. The apparatus of claim 12, wherein the instructions are further executable by the processor to cause the apparatus to:
determine that the active antenna module is to be replaced by one of the candidate antenna modules;
transition the active antenna module to be a candidate antenna module; and
transition the one of the candidate antenna modules to be a replacement active antenna module.

15. The apparatus of claim 14, wherein the instructions to determine that the active antenna module is to be replaced by the one of the candidate antenna modules are executable by the processor to cause the apparatus to:
determine that the one of the candidate antenna modules has a stronger key performance indicator with respect to configured transmission configuration indication state or beam than the active antenna module has with respect to the configured transmission configuration indication state or beam.

16. The apparatus of claim 15, wherein the key performance indicator comprises at least one of a reference signal received power, a reference signal received quality, a signal to noise ratio, or a combination thereof.

17. The apparatus of claim 15, wherein the configured transmission configuration indication state comprises an active transmission configuration indication state and the beam comprises a serving beam.

18. The apparatus of claim 12, wherein the instructions are further executable by the processor to cause the apparatus to:
determine that at least one of the candidate antenna modules will not be used to replace the active antenna module within the leading time; and
transition the at least one of the candidate antenna modules to be an unused antenna module based at least in part on the determination.

19. The apparatus of claim 12, wherein the instructions are further executable by the processor to cause the apparatus to:
determine that at least one of the unused antenna modules is potentially to be used as a replacement antenna module to the active antenna module within the leading time; and
transition the at least one of the unused antenna modules to be a candidate antenna module based at least in part on the determination.

20. An apparatus for wireless communication at a user equipment (UE), comprising:
means for identifying an active transmission configuration indication state or serving beam of a base station to be used for one or more scheduled transmissions;
means for identifying an antenna module at the UE to be used as an active antenna module for receipt of the one or more scheduled transmissions via the active transmission configuration indication state or serving beam;
means for identifying one or more remaining antenna modules at the UE as either candidate antenna modules for potentially replacing the active antenna module within a leading time or as unused antenna modules; and
means for receiving the one or more scheduled transmissions via the active antenna module or via a replacement active antenna module selected from the candidate antenna modules.
